(19) United States
(12) Patent Application Publication
(10) Pub. No.: US 2009/0234737 A1
(43) Pub. Date: Sep. 17, 2009

(54) Method of promotion tracking

(76) Inventors: Seth H. Sarelson, New York, NY (US); Jonathan A. Treiber, New York, NY (US); Gregory Hansen, Twp. Of Washington, NJ (US)

Correspondence Address: HEDMAN & COSTIGAN P.C., 1185 AVENUE OF THE AMERICAS, NEW YORK, NY, 10036, US

(21) Appl. No.: 12/152,184

(22) Filed: May 13, 2008

Related U.S. Application Data
(60) Provisional application No. 61/036,509, filed on Mar. 14, 2008.

(51) Int. Cl. G06Q 30/00

(52) U.S. Cl. 705/14

(57) ABSTRACT

A method of marketing a merchant's goods and/or services comprising the steps of registering a merchant with an ASN to create a registered merchant, registering a publisher with the ASN to create a registered publisher, applying a unique promotion code to the registered publisher, delivering advertisements having the registered publisher's unique promotion code associated therewith to consumers, and accepting the unique promotion code at registered merchants for a transaction. The method also includes the steps of tracking the unique promotion code to the registered merchant and associating the unique promotion code with the consumer's transaction.

### FIELD OF THE INVENTION

The invention relates to the field of sales and marketing. More particularly, the invention relates to the creation, redemption, and tracking of promotions.

### BACKGROUND OF THE INVENTION

Traditional online affiliate sales/marketing networks (“ASN”) such as LINKSHARE®, COMMISSION JUNCTION®, PERFORMICS®, AZOOGLE®, and SHAREASALE® match merchants seeking pay-per-action marketing with internet publishers seeking to earn commissions by promoting a merchant's products and/or services. These ASNs eliminate the risk of ineffective marketing by only charging the merchant a fee when the publisher produces the desired result. The desired result may range from the sale of goods and/or services to registering a consumer for a subscription or service to any other action that the merchant would like a consumer to take. The publisher is paid only when a consumer completes the desired action with the merchant.

In the prior art, the ASN tracks each consumer's actions from the publisher's media campaign to the merchant's website and identifies whether the consumer completed the desired action. The ASN then reports this information back to both the merchant and publisher. The ASN bills and collects one payment from each merchant in a given time frame (for example, monthly) and then disburses commissions to each publisher in a given time frame (for example, monthly).

The merchant benefits from this method because the ASN provides pay-per-action marketing, thereby eliminating the risk that a particular marketing channel will not perform or will not perform as well as the merchant desires. If the marketing channel does not perform, the merchant pays nothing to the ASN or the publisher. For example, if the merchant has an agreement with the publisher to pay the publisher a 5% commission on every sale, and the publisher serves an ad which directly results in a sale for $100.00, the merchant pays the ASN $5 plus an affiliate network fee. The ASN keeps the affiliate network fee and delivers $5 to the publisher as payment for delivering a sale of $100.00 to the merchant.

The ASN allows the merchant to reach a very large number of publishers (and, therefore, a very large number of consumers) and select those publishers the merchant desires to use as a commission-based sales force (also known as an affiliate sales force) to promote the merchant's goods and/or services. The merchant may also choose to develop a direct relationship with the publisher.

The publisher benefits from this method because the ASN provides a way to easily and efficiently monetize consumer traffic on the publisher's web pages, email or other media campaign. The ASN may also provide the publisher with a set of standardized tools to select, display, and track impressions, clicks, revenue, and other metrics from merchant advertisements.

The ASNs are essentially hubs that match merchants with publishers and charge a fee on each commission that a merchant pays to a publisher. Historically, the ASN model has been incredibly successful because it is essentially risk-free for the merchant. The ASN model eliminates the needs for merchants and publishers to develop and integrate technology, directly exchange payments, or maintain a direct relationship.

This model, however, is flawed in that it can only function in an online environment for e-commerce wherein both the merchant and publisher have an online presence. Therefore, both offline merchants and offline publishers are excluded from taking advantage of the benefits offered by ASNs. At present, there is no type of ASN that can track and attribute actions taken by a consumer with an offline merchant back to a publisher and/or the consumer.

In today's marketplace, there is no effective method that allows an offline merchant to engage an affiliate sales force with pay-per-sale marketing. Therefore, offline merchants are forced to engage in marketing efforts that have substantial up-front costs. Direct mailings and other traditional media are not cost-effective, thus erecting a barrier that prevents merchants with less capital from engaging in effective marketing through traditional channels. Further, traditional marketing efforts have burdened merchants with up-front costs regardless of the successes of such efforts. A merchant must pay for a television advertisement, direct mail campaign, or newspaper advertisement regardless of whether or not revenue is generated from that advertisement or campaign. When revenue is generated, the merchant is often left guessing as to the effectiveness of each marketing method unless some form of tracking method (e.g., promotional codes or coupons) is used. The up-front costs and lack of transparency as to efficacy are a major source of frustration to a merchant's ad buyer(s).

Many publishers that work with traditional ASNs are loyalty/rewards program publishers that exist by remarketing the commissions paid to them by merchants. Remarketing is defined in this document as a method whereby a loyalty/rewards program publisher uses the commission paid to it by merchants to provide a financial incentive (such as cash-back, points, or other reward) to consumers to shop with a particular merchant. These loyalty/rewards program publishers earn their commissions as described above. However, rather than keeping the entire commission, the loyalty/rewards program publisher keeps a portion and sets aside the remaining portion of the commission to send back to the consumer. The consumer is thereby enticed to keep shopping at a particular merchant, to keep using a particular loyalty/rewards program publisher or both.

The remarketing amount can range from 0%-100% of the publisher's commission. For example, Merchant A offers a 5% commission on every sale to each publisher. A loyalty/rewards program publisher will keep, e.g., ⅕ of the commission and offer the consumer the remaining ⅘ as a cash-back rebate or other equivalent point value for shopping with the merchant. Loyalty/rewards program publishers offer many variations on this model, with specialized programs marketed using cash-back enticements for everything from funding 529 college savings plans to community fundraising efforts to charitable donations. These programs include UPROMISE®, IGIVE.COM®, IBAKESALE™, FUNDRAISERREWARDS®, SCHOOLPOP® and MYPOINTS®, as well as a variety of others.

Because traditional ASNs exclude offline merchants, commission opportunities are limited for many publishers, specifically the aforementioned loyalty/rewards program publishers, which could significantly increase their revenue by driving sales to offline merchants.

Because traditional ASNs exclude offline publishers, offline publishers cannot work with merchants on a pay-for-performance basis. Working on a pay-for-performance basis would eliminate much of the up-front costs and lack of transparency as to the efficacy of advertising that are a major source of frustration to a merchant's ad buyer(s).

For these and other reasons, it is desirable to provide a process that can track and attribute actions taken by a consumer with an offline merchant back to a publisher and/or the consumer.

### SUMMARY OF THE INVENTION

It is therefore an object of the present invention to provide a method whereby offline merchants may engage in pay-per-sale marketing with both offline and online publishers.

It is another object of the present invention to provide a method whereby offline merchants can track results of marketing efforts.

It is yet another object of the present invention to provide a method whereby offline and online publishers can utilize on-demand unique promotion codes to track and attribute transactions between consumers and merchants.

It is a further object of the present invention to provide publishers, especially loyalty/rewards program publishers and coupon publishers, with a new revenue opportunity to earn commissions by driving consumers to spend at offline merchants.

It is an even further object of the present invention to provide unique promotion codes to consumers thereby enabling consumers to receive rewards for offline shopping.

Accordingly, these objects and others not particularly set forth above are achieved by the method and system of the present invention which comprises the steps of registering merchants with a service; registering publishers with the same service; applying a unique promotion code to the registered publisher; delivering advertisements having the registered publisher's unique promotion code associated therewith to consumers; accepting the publisher's unique promotional code at registered merchants for a transaction; and tracking the unique promotion code to the merchant and associating it with the consumer's transaction.

The creation of a unique promotion code in accordance with the principles of the present invention enables attribution of a consumer's transaction to both the publisher and, optionally, the consumer, which enables pay-per-action marketing, providing a clear advantage over the prior art method which required a merchant to expend up-front funds on other media that does not tie marketing costs to actual merchant revenues.

The present invention provides a solution to the problem that traditional ASNs have only been able to support online merchants. The invention is a new type of ASN that can provide pay-per-sale marketing for offline merchants. In today's marketplace, and as previously discussed, offline merchants cannot engage in risk-free pay-per-sale marketing. The invention eliminates both the uncertainty and financial risk associated with traditional marketing efforts that are not directly tied to generated revenue.

The present invention also provides a solution to the problem that there is currently no method for publishers that utilize traditional ASNs to generate revenue from purchases made at offline merchants. The invention provides a new revenue stream from offline merchants for publishers that utilize traditional ASNs and remarket to consumers the commissions paid by merchants. The invention gives loyalty/rewards program publishers and other publishers the opportunity to earn commissions from a previously unreachable segment of the retail marketplace by using tracking technology that can be applied to any offline merchant, regardless of location.

Further, the invention provides a new marketing channel that allows offline merchants to engage both online and offline publishers as an affiliate sales force in an environment that is free of financial risk by creating the opportunity for publishers to generate revenue by driving consumers to spend at local offline merchants. These publishers can offer a variety of incentives to consumers for supporting local offline merchants.

The preferred embodiment of the present invention comprises the steps of:
a. registering a merchant to create a registered merchant;
b. registering a publisher to create a registered publisher;
c. applying a unique promotion code to the registered publisher;
d. delivering advertisements having the registered publisher's promotion code associated therewith to consumers;
e. accepting the unique promotion code at registered merchants for a transaction;
f. tracking the publisher's unique promotion code to the registered merchant and associating it with the consumer's transaction.

The advertisements that are delivered to the consumers can be embedded with the registered publisher's unique promotion code or the unique promotion code can be associated with the advertisement by any manner known to those of skill in the art. Additionally, the transaction between a consumer and a merchant as in step (e) can include, but is not limited to, the purchase of goods and/or services by a consumer or any other action that a merchant would desire that a consumer take.

The step of registering a merchant can be performed by several different entities including, but not limited to, a marketer, an ASN, a financial institution, a bank, a payments processor, a payment vehicle association, an affinity organization, a payment card issuer, a merchant, a media company, and combinations thereof. Steps (c) and (d) may optionally be performed by one or more methods selected from the group consisting of Web Service integration, HTTP servlet integration, user directed action within secured web session, and combinations thereof.

The step of registering a publisher can be performed by several different entities including, but not limited to, a marketer, a publisher, an ASN, a financial institution, a bank, a payments processor, a payment vehicle association, an affinity organization, a payment card issuer, a merchant, a media company, and combinations thereof.

The step of delivering advertisements to consumers can be performed by several different entities including, but not limited to rewards/loyalty programs, magazines, newspapers, printers, television networks, radio stations, web portals, blogs, search engines, internet websites, intranet websites, email marketers, video games, marketers, ASNs, financial institutions, banks, payments processors, mobile media companies, payment vehicle associations, affinity organizations, payment card issuers, merchants, media companies, and combinations thereof.

The steps of
accepting the unique promotion code at a registered merchant for a transaction;
tracking the unique promotion code at a registered merchant used in transactions;
reporting qualifying transactions;
charging the registered merchant a marketing fee; and/or
paying the registered publisher a marketing commission
   can be performed by several different entities including, but not limited to, merchants, marketers, ASNs, financial institutions, banks, payment processors, payment vehicle associations, affinity organizations, payment card issuers, media companies, and combinations thereof.

A second preferred embodiment of the present invention includes the step of applying the unique promotion code to a consumer or other user in addition to the publisher.

A third preferred embodiment of the present invention includes the step of encoding additional information into the unique promotion code that identifies the ASN, the value of the promotion, instructions to include or exclude certain product(s) or service(s), an expiration date, or any other relevant information.

A fourth preferred embodiment of the present invention includes the step of converting the unique promotion code into a secondary form including, but not limited to, barcodes, RFID tags, phone numbers, numeric codes, alphanumeric codes, images, and other methods of data storage.

A fifth preferred embodiment of the present invention includes the step of reporting qualifying transactions and associated unique promotion code to the ASN.

A sixth preferred embodiment of the present invention includes the step of charging a registered merchant a marketing fee when a unique promotion code has been used for a consumer's qualifying transaction.

A seventh preferred embodiment of the present invention includes the step of paying the registered publisher a marketing commission when a unique promotion code attributed to the registered publisher has been used by a consumer.

In the second embodiment, the unique promotion code of step (c) is also applied to a consumer or other user. The step of applying this unique promotion code that also identifies a consumer or other user can be performed by several different parties, including, but not limited to the merchant, a marketer, a publisher, an ASN, a bank or other financial institution, a payments processor, a payment vehicle association, an affinity organization, a payment card issuer, a media company, and combinations thereof.

In the third embodiment, the unique promotion code of step (c) is also applied to identify the ASN, the value of the promotion, instructions to include or exclude certain product(s) or service(s), an expiration date, or any other relevant information. The step of applying this unique promotion code can be performed by several different parties, including, but not limited to the merchant, a marketer, a publisher, an ASN, a bank or other financial institution, a payments processor, a payment vehicle association, an affinity organization, a payment card issuer, a media company, and combinations thereof.

In another embodiment, the invention further comprises the step of structuring a commission scale between a registered merchant and a registered publisher. This step can be performed by several different entities including, but not limited to a merchant, a marketer, a publisher, an ASN, a financial institution, a bank, a payments processor, a payment vehicle association, an affinity organization, a payment card issuer, a media company, and combinations thereof.

In the fourth embodiment, the invention further comprises the step of converting the unique promotion code into another identifiable form including, but not limited to, barcodes, RFID tags, phone numbers, numeric codes, alphanumeric codes, images, and other methods of data storage. The step of converting the unique promotion code into another identifiable form can be performed by several different entities including, but not limited to the merchant; rewards/loyalty program publishers and/or other publishers of magazines, newspapers, printers, television networks, radio stations, web portals, blogs, search engines, internet websites, intranet websites, email marketers and video games; marketers; ASNs; financial institutions; banks; payments processors; payment vehicle associations; affinity organizations; payment card issuers; media companies; and combinations thereof.

The term “merchant” includes, but is not limited to, offline merchants, online merchants and merchants with both an online and offline presence.

Offline merchants are defined in this document as merchant locations that are non-internet based. This includes both merchants that provide at least one physical location at which a consumer can shop (e.g., a retail storefront) and merchants that do not provide a storefront (e.g., mail order and telephone order catalogues). A merchant can be both online and offline, but the term “offline merchant” is directed to either that segment of a merchant's business that is conducted at a non-internet based location (e.g., a brick-and-mortar store or mail order catalogue) or to a merchant that conducts all its business at a non-internet based location or through, e.g., a mail order catalogue.

A payments processor is herein defined as a service company that performs charges and settlements for credit card transactions, debit card transactions and other payment transactions. A payment vehicle association is herein defined as an association of card-issuing banks such as VISA®, MASTERCARD®, DISCOVER®, AMERICAN EXPRESS®, etc. that set transaction terms for individual merchants, individual card-issuing banks, and individual acquiring banks. An affinity organization is herein defined as a group of individuals, companies, or other entities that have a shared affinity for an organization such as a company, sports team, airline, department store, alma mater, college alumni association, or other organization. A mobile media company is herein defined as a media company that uses mobile devices including, but not limited to, mobile phones, MP3 players, GPS devices, and other portable media and communications devices to provide advertisements, promotional offers and other content.

In this document, the term “publisher” includes, but is not limited to, creators, distributors, marketers or proprietors of rewards/loyalty programs, magazines, newspapers, printers, television networks, radio stations, web portals, blogs, search engines, internet websites, intranet websites, email marketers, video games, ASNs, financial institutions, banks, payments processors, payment vehicle associations, affinity organizations, payment card issuers, merchants, media companies, mobile media companies that distribute content via cell phones, personal display assistant (“PDA”) devices, global positioning system (“GPS”) devices, MP3 players, and other mobile devices, and other marketers. The manner in which a publisher distributes its product or content is known as a media campaign.

The term “publisher” also includes, but is not limited to an offline publisher, an online publisher, and a publisher with both an online and offline presence.

Offline publishers are defined in this document as those publishers that use non-internet based media to communicate with the consumer. This includes, but is not limited to, print media, radio, television, cell phones, PDA devices, GPS devices, MP3 players, and other mobile devices, personal solicitations, billboards and other public displays. Online publishers are defined in this document as those publishers that use the internet to communicate with the consumer. A publisher can be both online and offline, but the term “offline publisher(s)” is directed to either that segment of the publisher's business that is conducted via non-internet based media or to a publisher that conducts all its business via non-internet based media.

The consumer can include, but is not limited to, an individual, a group, an organization, a business, a private entity, a commercial entity, a government entity and combinations thereof.

The term “advertisements” as used in this document can include, but are not limited to, mail, email, text messages, SMS messages, MMS message, GPS advertisements, interactive voice responses, magazines ads, newspaper ads, mobile media, direct mail ads, shared mail ads, billboards, signs, movie ads, television ads, radio ads, ads on web portals, ads on blogs, ads on search engines, internet website ads, banner ads, popup ads, intranet website ads, ads on or in video games, podcasts, printed coupons, printable coupons, and any other type of print or interactive media and combinations thereof.

The term “unique promotion code” includes, but is not limited to, any type of numeric code, alphanumeric code, barcode, identification device, tracking code or other method that facilitates identification of any combination of the consumer(s), publisher(s), and other desired parties or information. Further, the term “qualifying transaction” is defined as any action or transaction that is associated with a unique promotion code.

It is envisioned that other modifications can be made to the invention. For example, a percentage of the registered publisher's marketing commission can be distributed to the consumer as a reward. The reward can be in any of several forms including, but not limited to, reward points, currency based rewards, cash back rewards and combinations thereof. The reward may be credited to the consumer in numerous ways including, but not limited to, cash-back, points, funding an account, or other reward.

### BRIEF DESCRIPTION OF THE DRAWINGS

The attached drawings are intended to better illustrate the present invention without limiting it in any manner whatsoever.

FIG. 1 is a schematic diagram illustrating a preferred embodiment of the present invention.

FIG. 2 is a schematic diagram illustrating a preferred embodiment of the creation of a unique promotion code.

FIG. 3 is a schematic diagram further illustrating the preferred embodiment of FIG. 1.

### DETAILED DESCRIPTION OF THE PRESENT INVENTION

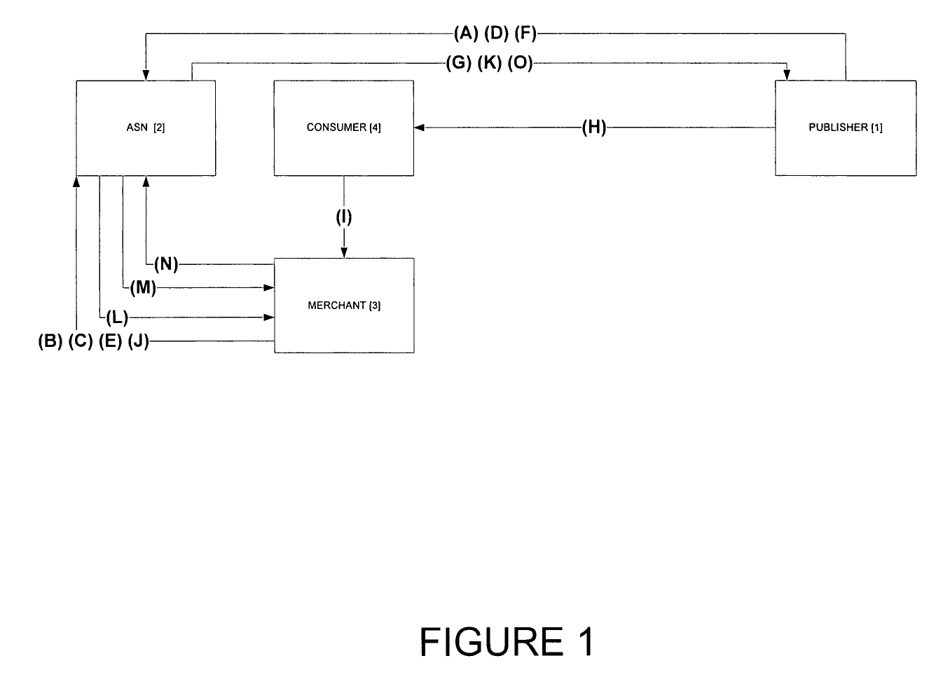

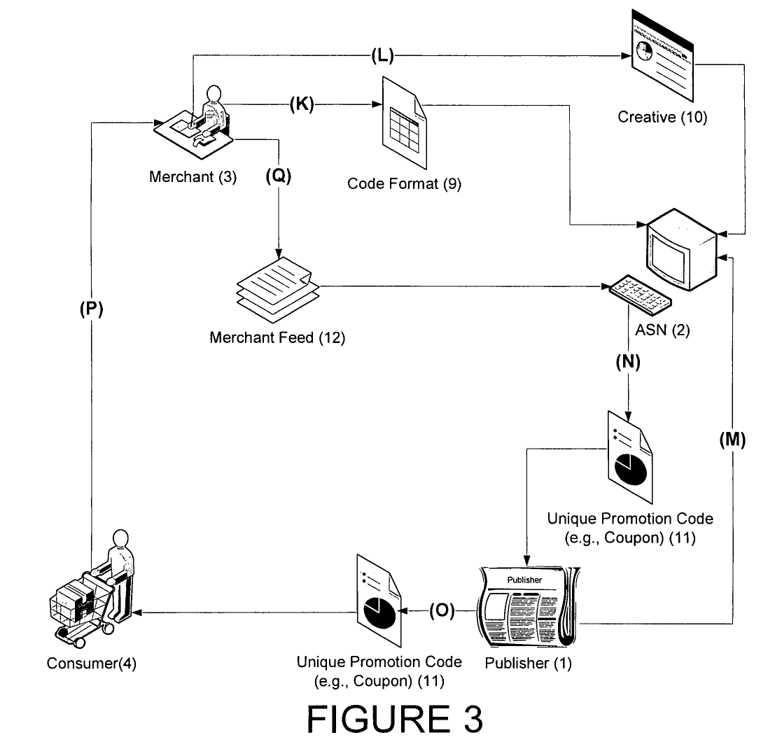

The following description is presented to describe the preferred embodiments of the present invention without limiting the scope of the appended claims. In FIGS. 1 and 3, for the sake of clarity, letters are used to designate steps while numbers are used to designate entities. In some cases, multiple steps are shown along a single path in order to clarify the diagram (e.g., steps designated as A, D, and F in FIG. 1 are all shown along the same path). This is not to be construed as being the same step designated in different ways. Rather, it is to be construed as different steps.

As best shown in FIG. 1, a publisher (1) registers (A) with the ASN (2), providing information about the type of publication, industry focus, consumer traffic/reach, contact information, legal information, payment information, and/or any other relevant information that is useful to a merchant who might consider working with the publisher. A merchant (3) registers (B) with the ASN (2), providing information about the merchant's industry, consumer focus, necessary banking information, and/or any other information that might be relevant including an optional unique promotion code format. The merchant (3) also creates terms and conditions for the publishers (1).

The merchant (3) creates a commission structure (C) with the ASN (2) for the publisher (1). The publisher (1) applies (D) to the ASN (2) to join a merchant's (3) affiliate sales force. The merchant (3) approves or declines (E), through the ASN (2), to work with a publisher (1) that has applied (D) to join the merchant's (3) affiliate sales force. If and when approved, the publisher (1) requests (F) a unique promotion code from the ASN (2) that identifies the publisher, and optionally identifies the consumer (4) or other promotion information. The ASN (2) then creates and transfers (G) this unique promotion code to the publisher (1).

The publisher (1) then advertises (H) to a consumer (4) to entice the consumer (4) to complete a transaction such as purchasing goods and/or services or taking another desired action (I) with the merchant (3), thereby (either knowingly or unknowingly) using the unique promotion code at participating merchants (3). This unique promotion code can be delivered in the form of a barcode or promotion code on a coupon or via RFID tags, phone numbers, alphanumeric codes, images, and other methods of data storage.

When the consumer (4) completes a transaction, the merchant (3) associates the unique promotion code with the consumer's (4) purchase or other desired action and optionally reports (J) qualifying transactions and associated unique promotion codes back to the ASN (2).

The ASN (2) provides reporting (K, L) to the publisher (1) and the merchant (3). The ASN (2) bills (M) the merchant (3) and the merchant sends (N) funds to the ASN (2). Once funds have been received by the ASN (2), the ASN (2) disburses funds (0) to the publisher (1). The ASN (2) may, at its option, keep a portion of the funds for itself.

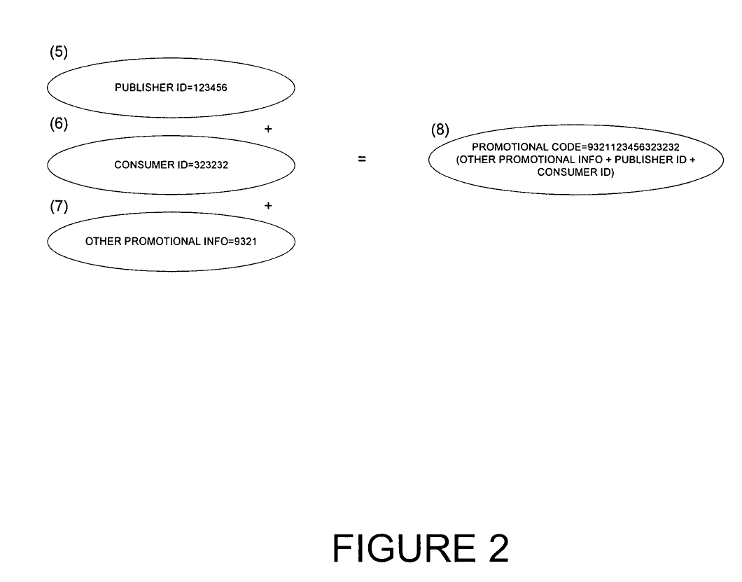

FIG. 2 depicts the creation of a unique promotion code. A publisher provides the publisher ID (5) (e.g., 123456) and, optionally, a consumer ID (6) (e.g., 323232) to the ASN. The ASN adds these fields to other promotion information (7) (e.g., 9321) and the unique promotion code (8) is created, which utilizes the information provided for tracking purposes. The phrase “other promotion information” includes, but is not limited to, a code identifying the ASN, a value code to determine the value of the promotion, codes to include or exclude certain product(s) or service(s), an expiration date, or any other relevant information. The merchant may then associate the unique promotion code with the consumer's transaction and may also report the qualifying transactions and associated unique promotion codes back to the ASN (see FIG. 1).

As best shown in FIG. 3, a merchant (3) specifies (K) an acceptable code format (9) with the ASN (2). The merchant (3) then uploads (L) pictures, artwork and/or text associated with a promotion (“promotional creative”) (10) to the ASN (2). The publisher (1) sends a request (M) for information to the ASN (2). The ASN (2) returns (N) a unique promotion code (11) to the publisher (1). The publisher then serves (0) this unique promotion code (11) to the consumer (4). The consumer (4) completes a transaction (P) with the merchant (3) using the unique promotion code (11). The merchant (3) associates the transaction made in step (P) with the unique promotion code (11) and sends (Q) a merchant feed of qualified transactions (12) to the ASN (2).

Variations, modifications and changes to the preferred methods described above will be apparent to those skilled in the art. All such variations, modifications and changes are intended to fall within the spirit and scope of the present invention, limited solely by the appended claims.

1. A method of marketing a merchant's goods and/or services comprising the steps of:
a. registering a merchant with an ASN to create a registered merchant;
b. registering a publisher with said ASN to create a registered publisher;
c. applying a unique promotion code to the registered publisher;
d. delivering advertisements having the registered publisher's unique promotion code associated therewith to consumers;
e. accepting said unique promotion code at registered merchants for a transaction;
f. tracking the publisher's unique promotion code to said registered merchant; and
g. associating said unique promotion code with said consumer's transaction.

2. The method of claim 1 wherein said merchant is selected from the group consisting of an offline merchant and a merchant with both an online and offline presence.

3. The method of claim 1 wherein step (a) is performed by one or more entities selected from the group consisting of a marketer, an ASN, a financial institution, a bank, a payments processor, a payment vehicle association, an affinity organization, a payment card issuer, a merchant, a media company, and combinations thereof.

4. The method of claim 1 wherein said publisher is selected from the group consisting of an offline publisher, an online publisher, and a publisher with both an online and offline presence.

5. The method of claim 1 wherein step (b) is performed by one or more entities selected from the group consisting of a marketer, a publisher, an ASN, a financial institution, a bank, a payments processor, a payment vehicle association, an affinity organization, a payment card issuer, a merchant, a media company, and combinations thereof.

6. The method of claim 1 wherein said registered publisher is selected from the group consisting of creators, distributors, marketers or proprietors of rewards/loyalty programs, magazines, newspapers, printers, television networks, radio stations, web portals, blogs, search engines, internet websites, intranet websites, email marketers, video games, ASNs, financial institutions, banks, payments processors, payment vehicle associations, affinity organizations, payment card issuers, merchants, media companies, mobile media companies that distribute content via cell phones, personal display assistant devices, global positioning system devices, MP3 players, and other mobile devices, and combinations thereof.

7. The method of claim 1 further comprising the step of structuring a commission scale between a registered merchant and a registered publisher.

8. The method of claim 7 wherein the step of structuring a commission scale between a registered merchant and a registered publisher is performed by one or more entities selected from the group consisting of the merchant, a marketer, a publisher, an ASN, a financial institution, a bank, a payments processor, a payment vehicle association, an affinity organization, a payment card issuer, a media company, and combinations thereof.

9. The method of claim 1 wherein said unique promotion code is also applied to a consumer.

10. The method of claim 1 wherein said unique promotion code is also applied to said ASN.

11. The method of claim 1 wherein steps (c) and/or (d) are performed by one or more methods selected from the group consisting of Web Service integration, HTTP servlet integration, user directed action within secured web session, and combinations thereof.

12. The method of claim 1 wherein said unique promotion code is converted into a secondary form including, but not limited to, barcodes, RFID tags, phone numbers, numeric codes, alphanumeric codes, images, and other methods of data storage.

13. The method of claim 1 wherein said consumer is selected from the group consisting of an individual, a group, an organization, a business, a private entity, a commercial entity, a government entity and combinations thereof.

14. The method of claim 1 wherein said advertisements are selected from the group consisting of mail, email, text messages, SMS messages, MMS messages, interactive voice responses, magazine ads, newspaper ads, mobile media, direct mail ads, shared mail ads, billboards, signs, movie ads, television ads, radio ads, ads on web portals, ads on blogs, ads on search engines, internet website ads, banner ads, popup ads, intranet website ads, ads on or in video games, podcasts, printed coupons, printable coupons, and any other type of print or interactive media and combinations thereof.

15. The method of claim 1 wherein step (f) is performed by one or more entities selected from the group consisting of merchants, marketers, ASNs, financial institutions, banks, payment processors, payment vehicle associations, affinity organizations, payment card issuers, media companies, and combinations thereof.

16. The method of claim 1 further comprising the step of reporting qualifying purchases of goods and/or services or other desired actions to the ASN.

17. The method of claim 1 further comprising the step of charging said registered merchant a marketing fee.

18. The method of claim 1 further comprising the step of paying said registered publisher a marketing commission.

19. The method of claim 18 wherein said registered publisher distributes a percentage of said marketing commission to said consumer as a reward.

20. The method of claim 19 wherein said reward is in the form of one or more selected from the group consisting of reward points, currency based reward, cash back reward, and combinations thereof.

21. The method of claim 1 wherein a registered merchant is charged one marketing fee per transaction.

22. The method of claim 18 wherein said marketing commission is paid to a plurality of publishers.

23. The method of claim 1 wherein said unique promotion code also identifies one or more selected from the group consisting of the value of the promotion, instructions to include or exclude certain product(s) or service(s), an expiration date, other relevant information and combinations thereof.

24. The method of claim 1 wherein said unique promotion code is selected from the group consisting of numeric codes, alphanumeric codes, barcodes, identification devices, tracking codes and combinations thereof.

25. The method of claim 1 wherein said unique promotion code is embedded into said advertisements.

26. The method of claim 1 wherein said transaction consists of one or more from the group consisting of the purchase of goods, the purchase of services, other actions desired by said merchant and combinations thereof.

27. The method of claim 1 wherein said advertisements are delivered to said consumers via said registered publisher's media campaign.
